(19) United States
(12) Patent Application Publication
(10) Pub. No.: US 2024/0311133 A1
(43) Pub. Date: Sep. 19, 2024

(54) IMAGE FORMING APPARATUS, FIRMWARE UPDATE METHOD, AND SYSTEM

(71) Applicant: SHARP KABUSHIKI KAISHA, Osaka (JP)

(72) Inventor: TAKUYA KOUJIRO, Osaka (JP)

(21) Appl. No.: 18/599,740

(22) Filed: Mar. 8, 2024

(30) Foreign Application Priority Data
Mar. 15, 2023 (JP) 2023-041338

(51) Int. Cl. G06F 8/65; G06F 3/12

(52) U.S. Cl. CPC G06F 8/65; G06F 3/1203; G06F 3/121; G06F 3/123; G06F 3/1239; G06F 3/1285

(57) ABSTRACT

According to an embodiment, an image forming apparatus includes: a communication device which receives a remotely-given update instruction to update firmware; a display device which displays an operation screen; and a processor which controls processing related to an update of the firmware, and the processor controls, on the basis of the update instruction that has been received, display contents of the operation screen displayed by the display device or an update start timing of the firmware, according to the apparatus status at the time of the update.

### BACKGROUND OF THE INVENTION

### Field of the Invention

The present disclosure relates to, for example, an image forming apparatus. This application is based upon and claims the benefit of priority from the prior Japanese Patent Application No. 2023-041338, filed Mar. 15, 2023, the entire contents of which are incorporated herein by reference.

### Description of the Background Art

Image forming apparatuses, such as multifunction peripherals, can keep the apparatuses themselves in a good state by updating firmware distributed from a manufacturer or a dealer. Generally, when firmware for update is released, processing of updating the firmware is performed by a service provider who undertakes the maintenance and management of the image forming apparatus, or by a user (hereinafter simply referred to as an administrator) who has the administrative rights to manage the image forming apparatus.

General firmware update processing assumes, for example, a case where an update instruction is remotely given from an outside entity such as a service provider or the like and a case where an administrator of an image forming apparatus sets an automatic update via a system setting screen or the like.

For example, there has been proposed a technology of performing firmware update processing for an information processor via an operation screen of a remote UI using a Web browser.

Conventionally, in the firmware update processing based on an update instruction, no consideration has been made to the apparatus status of an image forming apparatus at the time of starting the update.

An object of the present disclosure is to provide an image forming apparatus and the like which can improve the convenience of a user by appropriately performing, according to the apparatus status at the time of firmware update, control related to an update of the firmware.

### SUMMARY OF THE INVENTION

In order to solve the above problem, an image forming apparatus according to the present disclosure is provided with: a receiver which receives a remotely-given update instruction to update firmware; a display which displays an operation screen; and a controller which controls processing related to an update of the firmware, and the image forming apparatus is characterized in that the controller controls, on the basis of the update instruction that has been received, display contents of the operation screen displayed on the display or an update start timing of the firmware, according to an apparatus status at the time of the update.

Also, a firmware update method according to the present disclosure is characterized by receiving a remotely-given update instruction to update firmware, and controlling, on the basis of the update instruction that has been received, display contents of an operation screen displayed by a display device or an update start timing of the firmware, according to an apparatus status at a time of the update.

According to the present disclosure, it is possible to provide an image forming apparatus and the like which can improve the convenience of a user by appropriately performing, according to the apparatus status at the time of firmware update, control related to an update of the firmware.

### BRIEF DESCRIPTION OF THE DRAWINGS

FIG. 1 is a diagram illustrating a form of connection of a multifunction peripheral according to a first embodiment to a network.

FIG. 2 is a diagram illustrating a functional configuration of the multifunction peripheral according to the first embodiment.

FIG. 3 is a diagram illustrating a form of a data structure of a firmware management table.

FIG. 4 is a diagram illustrating a functional configuration of a firmware providing apparatus according to the first embodiment.

FIG. 5 is a diagram illustrating a form of a data structure of a firmware update setting table.

FIG. 6 is a flowchart illustrating a flow of processing according to the first embodiment.

FIG. 7 is a flowchart illustrating a flow of processing according to the first embodiment.

FIG. 8 is a flowchart illustrating a flow of processing according to the first embodiment.

FIG. 9 is a flowchart illustrating a flow of processing according to the first embodiment.

FIG. 10 is a diagram illustrating an operation example according to the first embodiment.

FIG. 11 is a diagram illustrating an operation example according to the first embodiment.

FIG. 12 is a diagram illustrating an operation example according to the first embodiment.

FIG. 13 is a diagram illustrating an operation example according to the first embodiment.

FIG. 14 is a diagram illustrating an operation example according to the first embodiment.

FIG. 15 is a diagram illustrating an operation example according to the first embodiment.

FIG. 16 is a diagram illustrating an operation example according to the first embodiment.

FIG. 17 is a flowchart illustrating a flow of processing according to a second embodiment.

FIG. 18 is a diagram illustrating an operation example according to the second embodiment.

FIG. 19 is a diagram illustrating an operation example according to the second embodiment.

FIG. 20 is a diagram illustrating an operation example according to the second embodiment.

### DESCRIPTION OF THE PREFERRED EMBODIMENTS

Embodiments of the present disclosure will be described below with reference to the accompanying drawings. Note that the embodiments described below are presented as examples for illustrating the present disclosure, and the technical scope of the embodiments as recited in the appended claims is not limited by the following description.

Firmware update processing for an image forming apparatus can be carried out on the basis of an update instruction issued remotely or an update instruction related to an automatic update set via a system setting screen of the image forming apparatus. For example, when an update date and time to start the firmware update is specified in the above-mentioned update instruction, the image forming apparatus starts update processing of updating the firmware at the date and time (an update start timing) specified as the update date and time.

Although the setting contents such as the update date and time specification included in the update instruction can be ascertained by a service provider who remotely issues the update instruction or an administrator of the image forming apparatus, it is difficult for a (general) user who uses the image forming apparatus to ascertain the setting contents.

Also, it is difficult to predict what the apparatus status will be for the image forming apparatus on the date and time specified as the update date and time. For example, in a case where there is occurrence of power-off such as a power failure or where an input job is being processed at an update start timing of firmware, the update processing cannot be carried out.

As described above, with respect to an update of firmware, if the user is not notified of the update or no consideration is made to the apparatus status of the image forming apparatus at the time of starting the update, a situation in which the update of the firmware may be executed at a timing not intended by the user, or conversely, the update of the firmware may not be executed at a timing intended by the user may be brought about.

In the present disclosure, an image forming apparatus, which can improve the convenience of the user by appropriately performing, on the basis of the contents of a firmware update instruction, control related to the update of the firmware according to the apparatus status at the time of the firmware update, is realized by the embodiments described below.

### 1. First Embodiment

In a first embodiment, a multifunction peripheral, which is capable of performing a job executed by a device in each mode, such as printing, copying, scanning, faxing, or Internet faxing, and the like, in a single housing, will be described as one form of an image forming apparatus. The multifunction peripheral according to the first embodiment corresponds to an image forming apparatus capable of executing a firmware update at an update date and time (i.e., an update start timing) specified by an update instruction. In the first embodiment, a mode of executing a firmware update of a multifunction peripheral (a device) on the basis of a firmware update instruction that has been remotely output from a firmware providing apparatus will be described. Note that, as will be described later, the firmware update can also be performed by having an administrator of the image forming apparatus set an automatic update via a system setting screen or the like and acquiring firmware related to the update from the firmware providing apparatus.

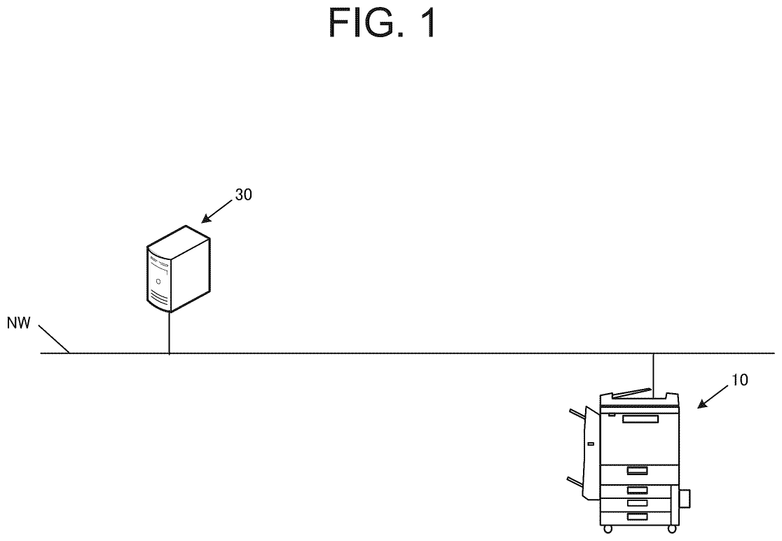

FIG. 1 is a diagram schematically illustrating a configuration of a form of connection of a multifunction peripheral 10 and a firmware providing apparatus 30. The multifunction peripheral 10 is connected such that communication with the firmware providing apparatus 30 is enabled via a network NW such as a local area network (LAN), a wide area network (WAN), the Internet, a telephone line, or a fax line. Although FIG. 1 illustrates a form in which the multifunction peripheral 10 is connected to the same network NW as the firmware providing apparatus 30, the multifunction peripheral 10 may be connected via a different network NW. Further, a plurality of multifunction peripherals 10 may be connected to the network NW.

### 1.1 Functional Configuration

### 1.1.1 Regarding Multifunction Peripheral 10

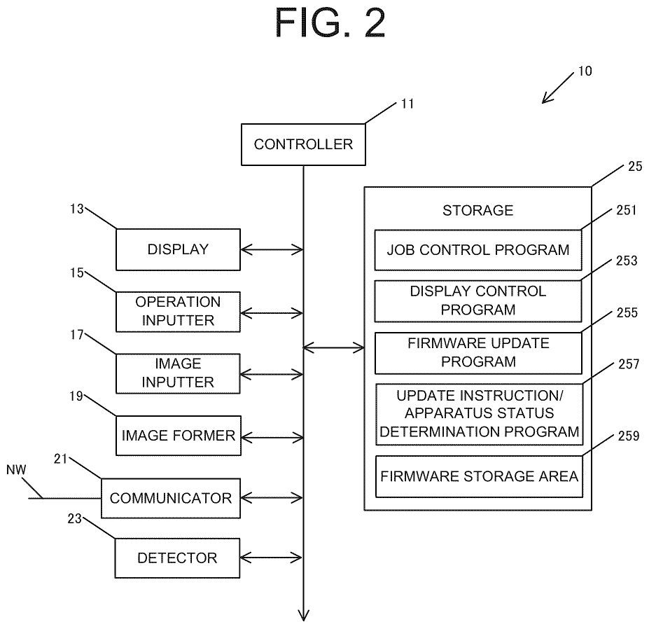

A functional configuration of the multifunction peripheral 10 according to the first embodiment will be described with reference to FIG. 2. FIG. 2 is a functional configuration diagram of the multifunction peripheral 10. The multifunction peripheral 10 is provided with a controller 11, a display 13, an operation inputter 15, an image inputter 17, an image former 19, a communicator 21, a detector 23, and a storage 25.

The controller 11 controls the multifunction peripheral 10 as a whole. The controller 11 is composed of, for example, one or more arithmetic devices (such as central processing units [CPUs]). The controller 11 reads various programs stored in the storage 25 and controls devices such as the image inputter 17, the image former 19, the communicator 21, the detector 23, and the like, thereby implementing the functions thereof.

The display 13 displays various kinds of information to a user, for example. The display 13 can be composed of a display device such as a liquid crystal display (LCD) or an organic electro-luminescence (EL) display. The display 13 displays, on the basis of control by the controller 11 that has read a display control program 253, a home screen, a job execution screen, a system setting screen, and the like, as an operation screen.

The operation inputter 15 receives input of information by the user or the like. The operation inputter 15 can be configured from an input device such as a hard key (e.g., a numeric keypad) or buttons, etc. The operation inputter 15 can be configured as a touch panel that allows input to be made via the display 13. In this case, for example, a common method such as a resistive method, an infrared method, an electromagnetic induction method, or a capacitive sensing method may be adopted as an input method for the touch panel.

The image inputter 17 can be configured, for example, as a scanner device provided with an image sensor, such as a charge-coupled device (CCD) or a contact image sensor (CIS), an automatic document feeder (ADF), and a flatbed for placing a document thereon, etc. In this case, as long as the scanner device has a configuration whereby it is possible to generate image data by reading a reflected light image from a document image with the image sensor, the configuration is not particularly limited. The image inputter 17 may also be configured as an interface capable of acquiring, for example, an image data file that is stored in an external storage device (device) such as a universal serial bus (USB) memory, or image data received via the network NW.

The image former 19 forms, on paper or the like as a recording medium, an image based on image data that has been input from the image inputter 17. The image former 19 feeds paper from a paper feeder (not illustrated), forms an image based on the image data on the paper, and thereafter discharges the paper to a paper discharger (not illustrated). The image former 19 can be composed of a laser printer or the like using an electrophotographic method, for example. In this case, the image former 19 forms an image by using toners supplied from toner cartridges, which are not illustrated, corresponding to respective toner colors (e.g., cyan, magenta, yellow, and black).

The communicator 21 is provided with either of or both of wired/wireless interfaces necessary for performing communication with another device (the firmware providing apparatus 30) via the network (NW) such as the LAN, the WAN, the Internet, the telephone line, or the fax line, for example. The communicator 21 functions as a receiver, and can receive a remotely-given firmware update instruction.

Not only does the detector 23 include various sensors related to image formation, which are for monitoring the apparatus state of the multifunction peripheral 10, more specifically, an environment sensor such as a temperature and humidity sensor and a medium position sensor for detecting the position of a recording medium in the image inputter 17 or the image former 19, for example, the detector 23 also includes a human detection sensor for detecting a user who is present in the vicinity of the multifunction peripheral 10. Although the type of a human detection sensor is not particularly limited, an infrared sensor, a sound sensor, an ultrasonic sensor, and a touch sensor, for example, are examples of the human detection sensor.

The storage 25 stores therein various kinds of data and various programs necessary for operation of the multifunction peripheral 10. The storage 25 can be configured from, for example, storage devices such as a random-access memory (RAM), a hard disk drive (HDD), a solid state drive (SSD), and a read-only memory (ROM).

In the first embodiment, the storage 25 stores a job control program 251, a display control program 253, a firmware update program 255, and an update instruction/apparatus status determination program 257, and reserves a firmware storage area 259.

The job control program 251 is a program that the controller 11 reads in order to perform processing related to each mode such as printing, copying, scanning, faxing, Internet faxing, and the like, on a job-by-job basis. The controller 11 that has read the job control program 251 executes a job by controlling the devices such as the display 13, the operation inputter 15, the image inputter 17, the image former 19, the communicator 21, the detector 23, and the like.

The display control program 253 is a program that the controller 11 reads in performing display control of an operation screen via the display 13. The controller 11 that has read the display control program 253 displays, for example, a home screen, a job execution screen, a system setting screen, or various operation screens related to firmware update on the display 13.

The firmware update program 255 is a program that the controller 11 reads in receiving a firmware update instruction. The controller 11 that has read the firmware update program 255 executes, on the basis of the contents of a firmware update instruction that has been input remotely or an update instruction pertaining to automatic update setting, processing related to firmware update according to the apparatus status. The controller 11 that has read the firmware update program 255 issues an instruction to display, for example, an update setting screen related to firmware update which will be described later or various message screens, etc. Also, the controller 11 that has read the firmware update program 255 controls the display contents of the operation screen displayed on the display 13 or an update start timing or the like of the firmware according to the contents of the update instruction and the apparatus status of the multifunction peripheral 10.

The update instruction/apparatus status determination program 257 is a program that the controller 11 reads in analyzing the firmware update instruction that has been input or determining the apparatus status of the multifunction peripheral 10. The controller 11 that has read the update instruction/apparatus status determination program 257 analyzes the update instruction that has been input remotely or the update instruction pertaining to automatic update setting. When the analyzed update instruction includes specification of the update date and time, the controller 11 acquires the relevant date and time information. Also, the controller 11 that has read the update instruction/apparatus status determination program 257 acquires various detection results obtained by the detection of the detector 23 and the status of job execution as the apparatus status. The update instruction and the apparatus information that have been acquired by reading of the update instruction/apparatus status determination program 257 are used for processing related to the firmware update.

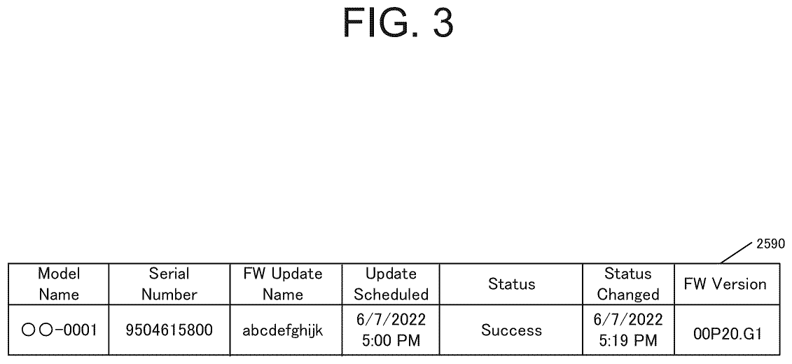

The firmware storage area 259 is a storage area for storing the firmware related to update and a firmware management table 2590 for managing update logs related to the firmware update. Here, the firmware management table 2590 will be described with reference to FIG. 3.

FIG. 3 is a diagram illustrating a configuration example of a data structure of the firmware management table 2590. The firmware management table 2590 includes, as management items, “Model Name”, “Serial Number”, “FW Update Name”, “Update Scheduled”, “Status”, “Status Changed”, and “FW Version”.

The “Model Name” represents the model name (○○-0001) of the multifunction peripheral 10. The “Serial Number” represents the serial number (9504615800) of the multifunction peripheral 10. The “FW Update Name” represents the name of the firmware (abcdefghijk) related to the update. The “Update Scheduled” represents the specification of the update date and time Jun. 7, 2022, 5:00 PM) of the firmware update. The “Status” represents the update result (Success). The “Status Changed” represents the date and time (Jun. 7, 2022, 5:19 PM) of completion of the firmware update and update made to the “Status”. The “FW Version” represents the version (00P20. G1) of the firmware related to the update.

Note that the management items managed by the firmware management table 2590 are not limited to the items described above, and the setting of the firmware management table 2590 can be changed as appropriate. When the controller 11 that has read the firmware update program 255 receives a firmware update instruction, the controller 11 refers to the firmware management table 2590 and verifies, for example, the name, the version, and the like, of the firmware applied to the update. By doing so, the controller 11 can determine whether the firmware for update is appropriate. For example, as a result of referring to the firmware management table 2590, if the firmware for update is not appropriate, the controller 11 can display, as an error message on the display 13, the fact that the firmware for update is not appropriate. Furthermore, the controller 11 can make, to a provider of the firmware for update (i.e., the firmware providing apparatus 30), a notification that the firmware for update is not appropriate, or a request for acquisition of appropriate firmware for update, for example.

### 1.1.2 Regarding Firmware Providing Apparatus 30

The firmware providing apparatus 30 is, for example, an external terminal device which is used by a manufacturer of the multifunction peripheral 10, a dealer, or an operator such as a service provider who undertakes the management and maintenance of the multifunction peripheral 10, is related to provision of firmware for update, and is capable of outputting an instruction to update the relevant firmware.

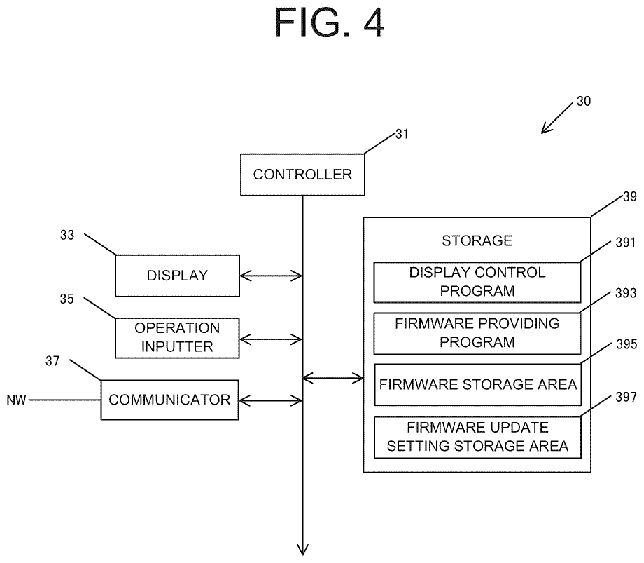

FIG. 4 is a functional configuration diagram of the firmware providing apparatus 30. The firmware providing apparatus 30 is provided with a controller 31, a display 33, an operation inputter 35, a communicator 37, and a storage 39.

The controller 31 controls the firmware providing apparatus 30 as a whole. The controller 31 is composed of, for example, one or more arithmetic devices (such as CPUs). The controller 31 reads and executes various programs stored in the storage 39, thereby implementing respective functions.

The display 33 displays various kinds of information to the user, for example. The display 33 can be composed of a display device such as an LCD, an organic EL display, a micro-LED display, or a mini-LED display.

The operation inputter 35 is an input device which receives input of information from the user or the like. The operation inputter 35 can be configured from input devices such as a keyboard, a mouse, and a touch panel, for example.

The communicator 37 is provided with either of or both of wired/wireless communication interfaces necessary for performing communication with another device (the multifunction peripheral 10) via the network (NW) such as the LAN, the WAN, the Internet, the telephone line, or the fax line, for example. The communicator 37 communicates with the multifunction peripheral 10, and can provide a firmware update instruction, firmware itself for update, and the like.

The storage 39 stores therein various kinds of data and various programs necessary for operation of the firmware providing apparatus 30. The storage 39 can be configured from, for example, storage devices such as a RAM, an HDD, an SSD, and a ROM.

In the first embodiment, the storage 39 stores a display control program 391 and a firmware providing program 393, and reserves a firmware storage area 395 and a firmware update setting storage area 397.

The display control program 391 is a program that the controller 31 reads in performing display control of a display screen via the display 33. The controller 31 that has read the display control program 391 displays, for example, a firmware update setting screen, etc., which will be described later.

The firmware providing program 393 is a program that the controller 31 reads in providing firmware for update. The controller 31 that has read the firmware providing program 393 refers to a firmware update setting table which will be described later, and if an update date and time of the firmware is specified, the controller 31 outputs, to the multifunction peripheral 10, an update instruction so that the firmware is updated on the specified update date and time. The controller 31 that has read the firmware providing program 393 outputs the firmware for update to the multifunction peripheral 10.

The firmware storage area 395 is a storage area for storing the firmware for update. The firmware for update may be provided in such a way that the firmware for update is provided from an external device such as a server other than the firmware providing apparatus 30.

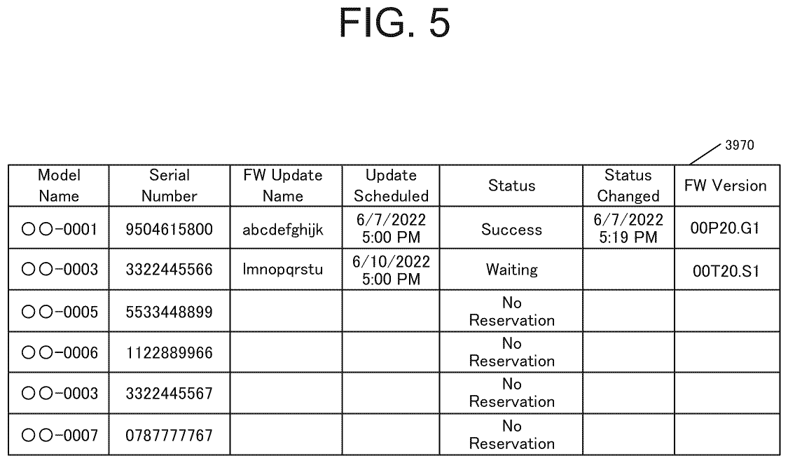

The firmware update setting storage area 397 is a storage area for storing a firmware update setting table 3970 for managing firmware update settings. Here, the firmware update setting table 3970 will be described with reference to FIG. 5.

FIG. 5 is a diagram illustrating a configuration example of a data structure of the firmware update setting table 3970. The firmware update setting table 3970 includes, as management items, “Model Name”, “Serial Number”, “FW Update Name”, “Update Scheduled”, “Status”, “Status Changed”, and “FW Version”.

The “Model Name” represents the model name of the multifunction peripheral 10, which is managed as a providing destination of the firmware for update. The “Serial Number” represents the serial number of the multifunction peripheral 10, which is managed as the providing destination of the firmware for update. The “FW Update Name” represents the name of the firmware related to the update. The “Update Scheduled” represents the update date and time of the firmware update that has been set. The “Status” represents the update result. The “Status Changed” represents the date and time of completion of the firmware update and update made to the “Status”. The “FW Version” represents the version of the firmware related to the update.

For example, the firmware update setting identified by the Model Name “○○-0001” and the Serial Number “9504615800” is the firmware update setting for the multifunction peripheral 10. Note that in a case where the firmware providing apparatus 30 manages a firmware update for an image forming apparatus other than the multifunction peripheral 10, the firmware providing apparatus 30 can manage setting information similar to that of the firmware update setting for the multifunction peripheral 10. For example, the firmware update setting identified by the Model Name “○○-0003” and the Serial Number “3322445566” is the firmware update setting for the image forming apparatus identified by the Model Name “○○-0003” and the Serial Number “3322445566”. The aforementioned firmware update setting represents the state in which the firmware update is specified to be performed on the update date and time Jun. 10, 2022, 5:00 PM), and the firmware update is held until the relevant update date and time arrives (Status “Waiting”).

### 1.2 Flow of Processing

### 1.2.1 Regarding Processing of Multifunction Peripheral 10

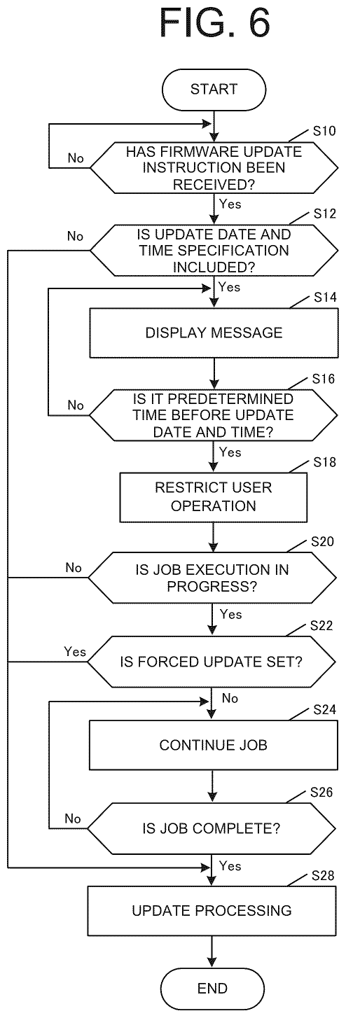

Next, a flow of processing according to the first embodiment will be described. FIG. 6 is a flowchart which illustrates processing related to an update of firmware in the multifunction peripheral 10, and illustrates processing in a case in which a firmware update instruction includes update date and time specification which specifies the date and time of the firmware update. The processing illustrated in FIG. 6 is processing executed by the controller 11 of the multifunction peripheral 10 as the controller 11 mainly reads the display control program 253, the firmware update program 255, the update instruction/apparatus status determination program 257, and the like.

First, the controller 11 determines whether an update instruction to update firmware, i.e., a firmware update instruction, has been received from the firmware providing apparatus 30 (step S10). If it is determined that the firmware update instruction has been received, the controller 11 analyzes the received update instruction and determines whether the update instruction includes specification of the update date and time, i.e., update date and time specification (step S10; Yes→step S12). Here, if it is determined that no firmware update instruction has been received, the controller 11 waits until a firmware update instruction is received (step S10; No).

In step S12, if it is determined that the update instruction includes the update date and time specification, the controller 11 displays, on the display 13, a message which urges that the multifunction peripheral 10 should not be powered off on the date and time specified by the aforementioned update date and time specification (step S12; Yes→step S14).

Next, the controller 11 determines whether the current time is predetermined time before the date and time specified by the update date and time specification (step S16). If it is determined that the current time is predetermined time before the date and time specified by the update date and time specification, the controller 11 restricts the user's operation on the multifunction peripheral 10 (step S16; Yes→step S18). Here, if it is determined that the current time is not predetermined time before the date and time specified by the update date and time specification, the controller 11 continues to display the message (step S16; No→step S14).

After restricting the user's operation on the multifunction peripheral 10, the controller 11 determines whether a job such as a print job, for example, is being executed (step S20). If it is determined that a job is being executed, the controller 11 determines whether a forced update setting, which is the setting to forcibly update the firmware even when a job or other processing is being executed, is set (step S20; Yes→step S22).

If it is determined that the forced update setting is not set, the controller 11 continuously executes the job (step S22; No→step S24). Then, the controller 11 determines whether the job being executed has been finished (step S26). If it is determined that the job being executed has been finished, the controller 11 performs update processing of updating the firmware (step S26; Yes→step S28). Here, if it is determined that the job being executed has not been finished yet, the controller 11 continues the execution of the job (step S26; No→step S24).

Incidentally, in cases where it is determined in step S12 that the update instruction does not include the update date and time specification (step S12; No), it is determined in step 20 that the job is not being executed (step S20; No), or it is determined in step S22 that the forced update setting is set (step S22; Yes), the controller 11 performs the update processing of updating the firmware (step S28).

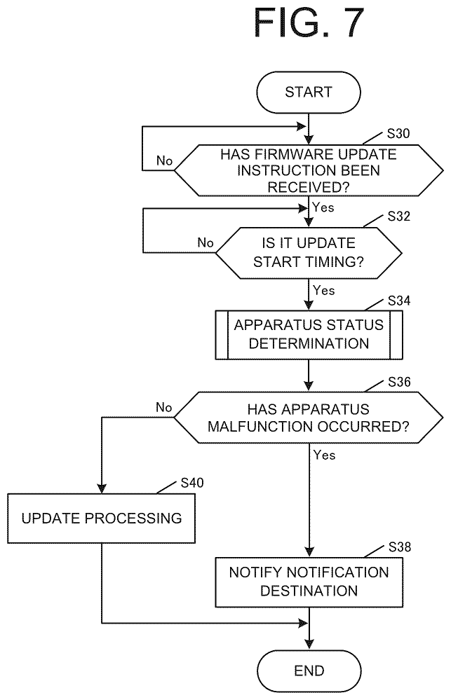

Next, FIG. 7 is a flowchart which illustrates processing related to an update of firmware in the multifunction peripheral 10, and illustrates processing in a case of determining whether or not update processing is to be performed according to the apparatus status of when a firmware update instruction is received.

First, the controller 11 determines whether an update instruction to update firmware, i.e., a firmware update instruction, has been received from the firmware providing apparatus 30 (step S30). If it is determined that the firmware update instruction has been received, the controller 11 determines whether a firmware update start timing has arrived (step S30; Yes→step S32). Meanwhile, if it is determined that no firmware update instruction has been received, the controller 11 waits until an update instruction is received (step S30; No).

If it is determined that the firmware update start timing has arrived, the controller 11 executes apparatus status determination processing (step S32; Yes→step S34). Meanwhile, if it is determined the firmware update start timing has not arrived yet, the controller 11 waits until the update start timing arrives (step S32; No). Incidentally, the controller 11 may omit the processing of step S32, and execute the apparatus status determination processing related to step S34 at the time when it is determined that the firmware update instruction has been received.

As a result of performing the apparatus status determination processing, if it is determined that there is occurrence of an apparatus malfunction, the controller 11 does not execute the firmware update, but notifies a notification destination, such as a service provider or an administrator, that the firmware update has failed (step S36; Yes→step S38).

Meanwhile, as a result of performing the apparatus status determination processing, if it is determined that there is no occurrence of an apparatus malfunction, the controller 11 executes update processing of updating the firmware (step S36; No→step S40).

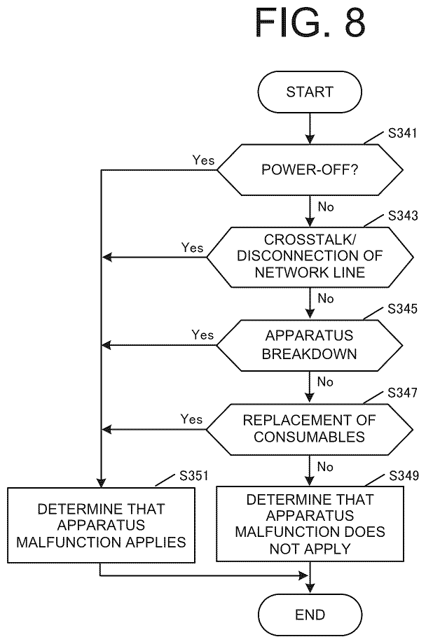

FIG. 8 is a flowchart illustrating the apparatus status determination processing related to step S34 of FIG. 7. In FIG. 8, the controller 11 determines, as the apparatus status, whether the status corresponds to a status in which the function of the multifunction peripheral 10 is prevented from being exerted due to an apparatus malfunction which has occurred by power-off, crosstalk/disconnection of a network line, an apparatus breakdown, or replacement of consumables, etc. In FIG. 8, to describe the apparatus status determination processing, the apparatus malfunction which has occurred in the multifunction peripheral 10 will be described. However, the apparatus status in question is not limited to the apparatus malfunction exemplified in FIG. 8. As the apparatus status, for example, a status in which the multifunction peripheral 10 is in the process of executing a job or other kinds of processing, and the update processing of updating the firmware is unable to be carried out at the timing of step S34 so that the update processing of updating the firmware fails can also be assumed.

When the controller 11 starts the apparatus status determination processing, the controller 11 determines whether the apparatus is in a status of being powered off, and supply of necessary electric power is prevented (step S341). If the controller 11 determines that the power is off, the controller 11 determines that an apparatus malfunction applies (step S341; Yes→step S351).

Meanwhile, if the controller 11 determines that the power is not off, the controller 11 determines whether there is occurrence of crosstalk/disconnection of a network line (step S341; No→step S343). If the controller 11 determines that there is occurrence of crosstalk/disconnection of the network line, the controller 11 determines that an apparatus malfunction applies (step S343; Yes→step S351).

Meanwhile, if the controller 11 determines that there is no occurrence of crosstalk/disconnection of the network line, the controller 11 determines whether there is occurrence of an apparatus breakdown (step S343; No→step S345). If the controller 11 determines that there is occurrence of an apparatus breakdown, the controller 11 determines that an apparatus malfunction applies (step S345; Yes→step S351).

Meanwhile, if the controller 11 determines that there is no occurrence of an apparatus breakdown, the controller 11 determines whether replacement of consumables such as toner or paper is being conducted (step S345; No→step S347). If the controller 11 determines that replacement of consumables is being conducted, the controller 11 determines that an apparatus malfunction applies (step S347; Yes→step S351).

Meanwhile, if it is determined that no replacement of consumables is being conducted, the controller 11 determines that the apparatus status does not correspond to an apparatus malfunction (step S347: No→step S349).

In the above description, a procedure of the processing in the case in which an update instruction to update firmware includes update date and time specification which specifies the date and time of the firmware update (FIG. 6), and a procedure of the processing in the case of determining whether or not update processing is to be performed according to the apparatus status of when a firmware update instruction is received (FIGS. 7 and 8) have been described individually. However, it is needless to say that these procedures of processing may be carried out as a series of processing procedures or as parallel processing procedures.

### 1.2.2 Regarding Processing of Firmware Providing Apparatus 30

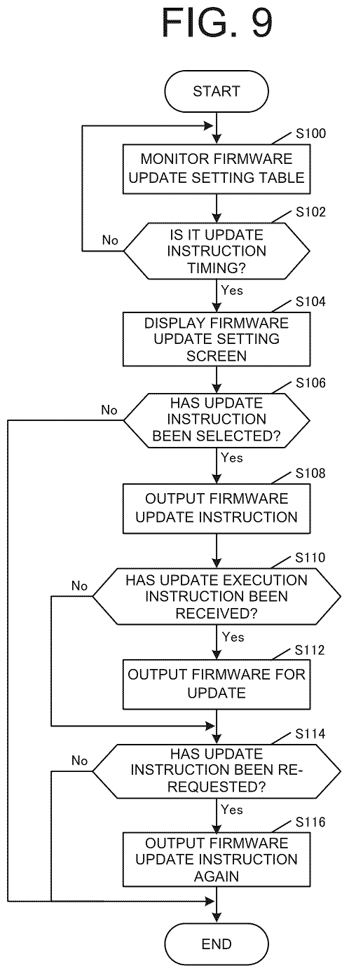

Next, a flow of processing in the firmware providing apparatus 30 will be described with reference to a flowchart of FIG. 9. The processing illustrated in FIG. 9 is processing executed by the controller 31 as the controller 31 mainly reads the display control program 391, the firmware providing program 393, and the like.

The controller 31 monitors the firmware update setting table 3970 and determines whether a firmware update instruction timing, which has been set in advance, has arrived (step S100→step S102). If it is determined that the firmware update instruction timing has arrived, the controller 31 displays the firmware update setting screen on the display 33 (step S102; Yes→step S104). Here, if it is determined that the firmware update instruction timing has not arrived yet, the controller 31 continues to monitor the firmware update setting table 3970 (step S102; No→step S100).

The controller 31 determines whether a firmware update instruction has been selected via the displayed firmware update setting screen (step S106). If it is determined that the firmware update instruction has been selected, the controller 31 outputs the firmware update instruction to the multifunction peripheral 10 (step S106; Yes→step S108). Here, if it is determined that the firmware update instruction has not been selected, the controller 31 ends the processing (step S106; No→End).

Next, the controller 31 determines, on the basis of the output firmware update instruction, whether an instruction to execute firmware update, i.e., a firmware update execution instruction, has been received from the multifunction peripheral 10 (step S110). If it is determined that the firmware update execution instruction has been received, the controller 31 outputs the firmware for update to the multifunction peripheral 10 (step S110; Yes→step S112). Meanwhile, if it is determined that no firmware update execution instruction has been received, the controller 31 shifts the processing to step S114 (step S110; No→step S114).

The controller 31 determines whether a re-request for the firmware update instruction has been received from the multifunction peripheral 10 (step S114). If it is determined that a re-request for the firmware update instruction has been received, the controller 31 outputs the firmware update instruction again and ends the processing (step S114; Yes→step S116). Meanwhile, if it is determined that no re-request for the firmware update instruction has been received, the controller 31 ends the processing (step S114; No→End).

### 1.3 Operation Examples

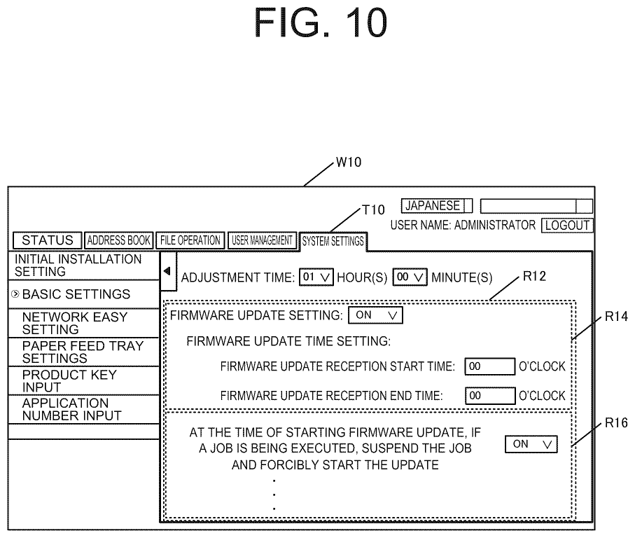

Next, operation examples according to the first embodiment will be described. FIG. 10 is a diagram illustrating a configuration example of a setting screen W10 in the multifunction peripheral 10.

The setting screen W10 includes a system setting tab T10. The system setting tab T10 displays setting information related to a system as a whole of the multifunction peripheral 10, and receives input of a setting value. The system setting tab T10 includes a firmware update setting area R12 for receiving the setting of automatic update related to firmware update.

The firmware update setting area R12 includes a basic setting area R14 and an advanced setting area R16. The basic setting area R14 includes a firmware update setting pull-down menu and firmware update time settings.

The firmware update setting pull-down menu receives the setting to enable or disable the firmware update. When a setting value of the firmware update setting pull-down menu is set to “ON”, the firmware update is enabled. Meanwhile, if the setting value is set to “OFF”, the firmware update is disabled.

The firmware update time settings receive the setting of a reception time period for the firmware update instruction. The controller 11 receives the firmware update instruction between the reception start time set at a firmware update reception start time and the reception end time set at a firmware update reception end time.

The advanced setting area R16 is an area for receiving advanced settings related to the firmware update. FIG. 10 displays, as an example of the advanced settings, a pull-down menu which receives selection of enabling or disabling the forced update setting to suspend, if a job is being executed at the time of starting a firmware update, the job and forcibly start the update. When a setting value of the forced update setting pull-down menu is set to “ON”, a forced update of the firmware is enabled. Meanwhile, if the setting value is set to “OFF”, a forced update of the firmware is disabled.

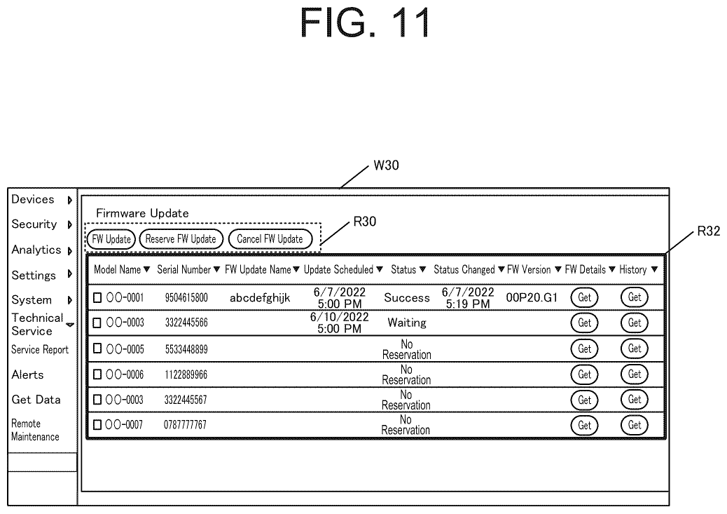

FIG. 11 is a diagram illustrating a configuration example of a firmware update setting screen W30 displayed on the display 33 by the controller 31 of the firmware providing apparatus 30. The firmware update setting screen W30 is a setting screen which receives settings related to a firmware update that are made remotely by an operator (a service provider or the like) of the firmware providing apparatus 30.

The firmware update setting screen W30 includes a firmware update operation selection area R30 and a firmware update setting display area R32.

The firmware update operation selection area R30 includes an “FW Update” button, a “Reserve FW Update” button, and a “Cancel FW Update” button. The “FW Update” button is a button which receives an instruction to output a firmware update. The “Reserve FW Update” button is a button which receives an instruction to reserve a firmware update. The “Cancel FW Update” button is a button which receives an instruction to cancel a firmware update.

As the operator of the firmware providing apparatus 30 selects various buttons provided in the firmware update operation selection area R30, the operator can output an instruction to execute processing related to a firmware update or cancel execution thereof.

The firmware update setting display area R32 is a display area for displaying the setting contents in the firmware update setting table 3970. As the operator of the firmware providing apparatus 30 confirms the display contents of the firmware update setting display area R32, the operator can issue a firmware update instruction and the like to the multifunction peripheral 10 being managed.

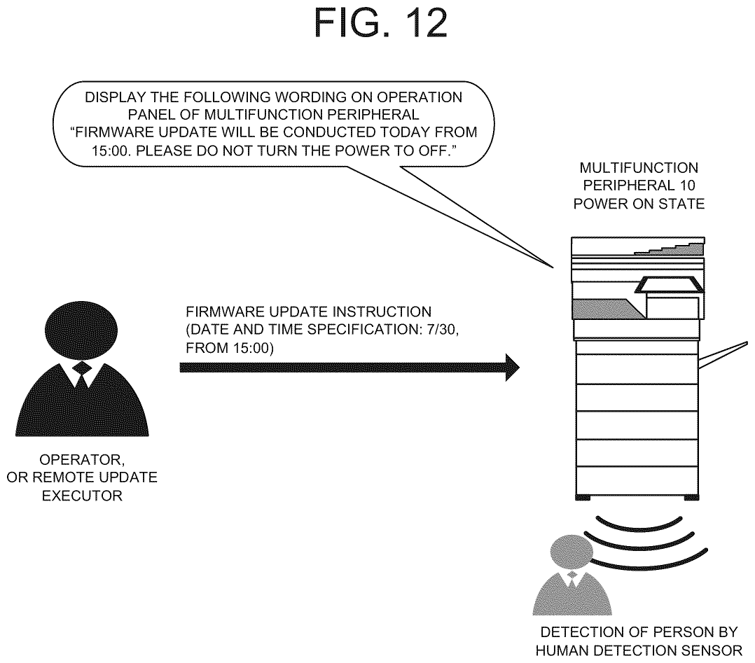

FIG. 12 is a diagram illustrating an operation example corresponding to the processing related to step S14 of FIG. 6. In FIG. 12, the firmware providing apparatus 30 issues a firmware update instruction to the multifunction peripheral 10 on the basis of the operator's instruction. At this time, in a case where the firmware update instruction includes update date and time specification, the controller 11 displays, on the display 13, a message (“Firmware update will be conducted today from 15:00. Please do not turn the power to OFF.”) with the purport to request that the power of the multifunction peripheral 10 should not be turned to OFF (i.e., that the multifunction peripheral 10 should not be powered off) on the date and time related to the update date and time specification. The controller 11 may constantly display the message on the display 13 when the power of the multifunction peripheral 10 is ON, or may display the message on the display 13 before execution of a job or when a human detection sensor (the detector 23) detects a person who is present around the multifunction peripheral 10.

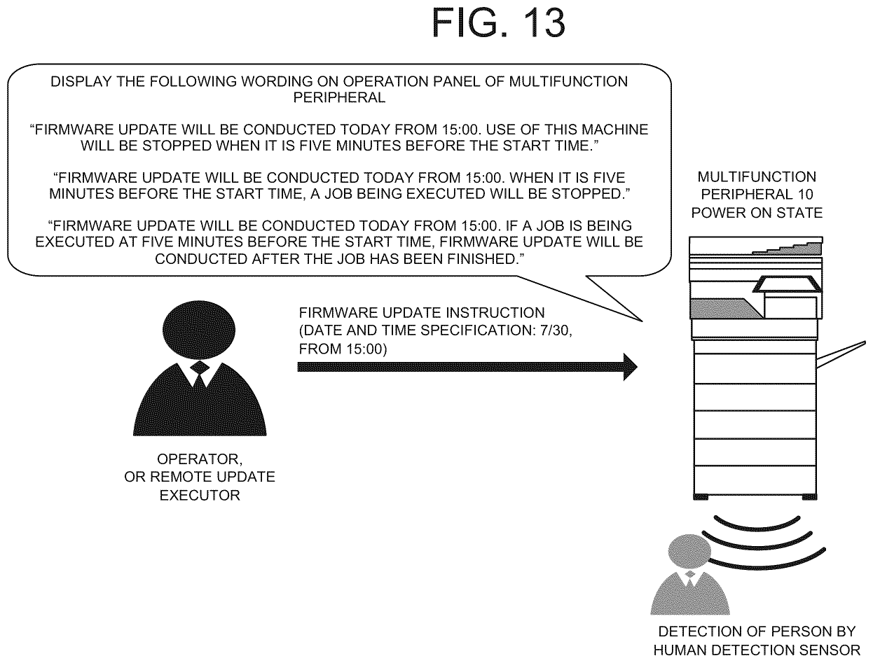

FIG. 13 is a diagram illustrating an operation example corresponding to the processing related to the steps from step S18 to step S28 of FIG. 6. In FIG. 13, the firmware providing apparatus 30 issues a firmware update instruction to the multifunction peripheral 10 on the basis of the operator's instruction. At this time, in a case where the firmware update instruction includes update date and time specification, when it is determined by the controller 11 that the current time is predetermined time before the date and time related to the update date and time specification, the controller 11 displays, on the display 13, a message (“Firmware update will be conducted today from 15:00. Use of this machine will be stopped when it is five minutes before the start time.”) with the purport to restrict the user' operation on the multifunction peripheral 10. In addition, if a job is being executed, the controller 11 displays, on the display 13, a message (“Firmware update will be conducted today from 15:00. When it is five minutes before the start time, a job being executed will be stopped.” or “Firmware update will be conducted today from 15:00. If a job is being executed at five minutes before the start time, firmware update will be conducted after the job has been finished.”) with the purport to stop the job being executed or perform update processing of updating the firmware after the job being executed has been finished. The controller 11 displays the message on the display 13 when the power of the multifunction peripheral 10 is ON, before execution of a job, or when a human detection sensor (the detector 23) detects a person who is present around the multifunction peripheral 10. Note that the message exemplified above may also take the form in which the message is displayed at a part of the area of the operation screen so that an operation of the operation screen is enabled until it is five minutes before the start time of the firmware update or it is the start time, and when it is five minutes before the start time or it is the start time, the message is displayed to cover substantially the entire area of the operation screen so that an operation via the operation screen is disabled (or the message is displayed at a part of the area of the operation screen whose operation buttons are disabled).

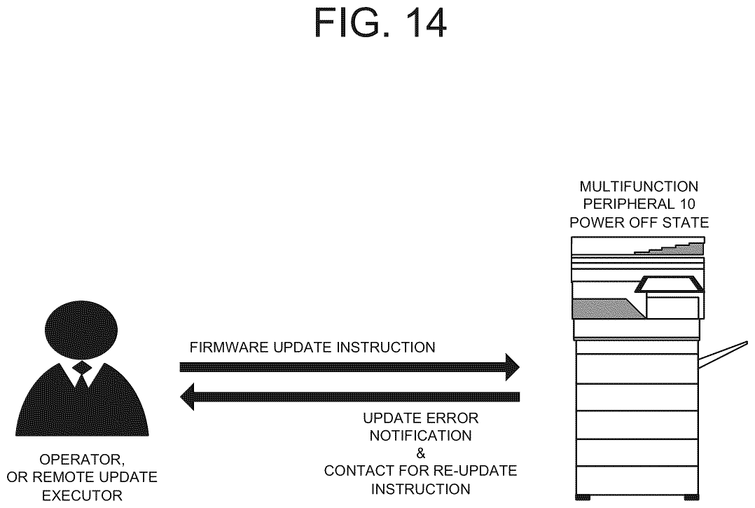

FIG. 14 is a diagram illustrating an operation example corresponding to the processing related to the steps from step S34 to step S38 of FIG. 7. In FIG. 14, the firmware providing apparatus 30 issues a firmware update instruction to the multifunction peripheral 10 on the basis of the operator's instruction. At this time, it is assumed that there is occurrence of an apparatus malfunction that the power is OFF (power-off) as the apparatus status, and the update processing of updating the firmware has failed. The controller 11 makes an update error notification, and also executes contact for a firmware re-update instruction to the operator of the firmware providing apparatus 30.

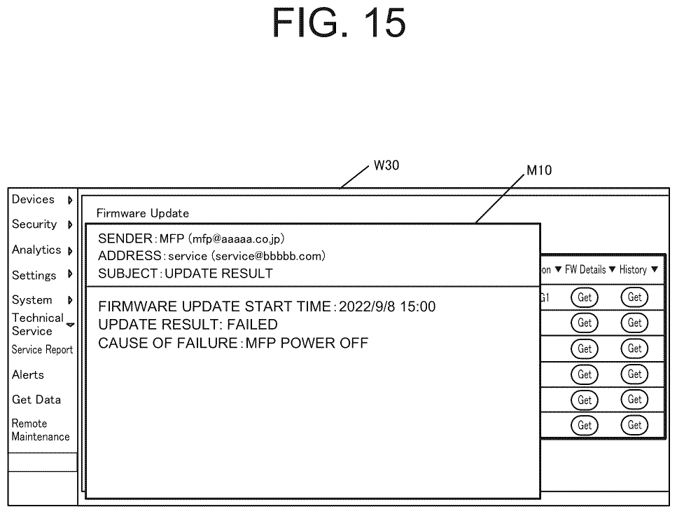

FIG. 15 is a diagram illustrating a configuration example of a mail reception screen M10 as an example of the error notification described with reference to FIG. 14. FIG. 15 illustrates an example which indicates, as the mail reception screen M10, firmware update start time (2022 Sep. 8 15:00), an update result (failed), and a cause of failure (MFP [multifunction peripheral 10] power OFF) as the reception contents. As the operator of the firmware providing apparatus 30 confirms the contents of the mail reception screen M10 received from the multifunction peripheral 10, the operator is able to know that the update processing of updating the firmware in the multifunction peripheral 10 has failed. Then, the operator outputs a firmware re-update instruction to the multifunction peripheral 10.

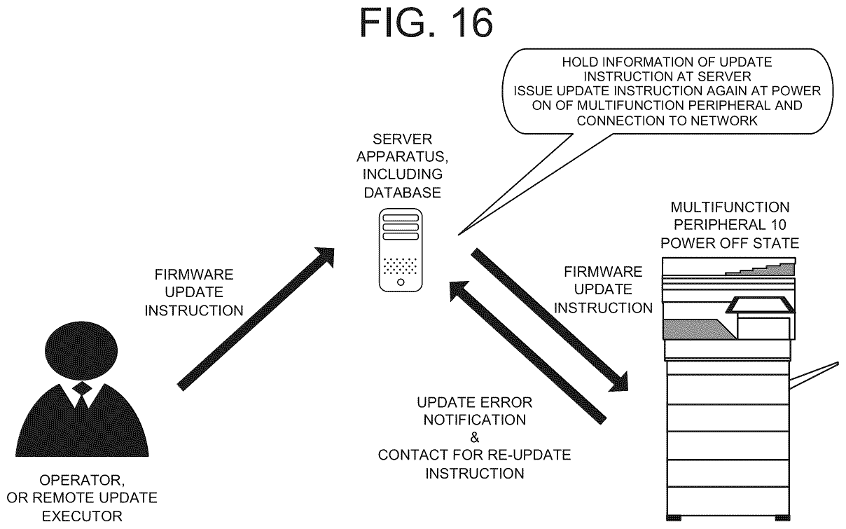

FIG. 16 is a diagram illustrating an example of an output form of a firmware update instruction. As illustrated in FIG. 16, the firmware providing apparatus 30 outputs a firmware update instruction to the multifunction peripheral 10 via a server apparatus (including a database). When the multifunction peripheral 10 is in a power OFF state, the controller 11 of the multifunction peripheral 10 makes an update error notification indicating that the firmware update has failed to the server, and also contacts the server for a re-update instruction. The server holds information related to the firmware update instruction, and can start the processing related to the firmware update at the timing when the power of the multifunction peripheral 10 is turned to ON and connection to a network is confirmed.

As described above, according to the first embodiment, on the basis of the contents of a firmware update instruction such as the update date and time specification, it is possible to appropriately perform control related to update of the firmware according to the apparatus status (e.g., an occurrence situation of an apparatus malfunction) at the time of the firmware update. According to the first embodiment, since an update of firmware can be carried out at a timing intended by the user, it is possible to improve the convenience of the user.

### 2. Second Embodiment

A second embodiment corresponds to an embodiment which, in the first embodiment, when a finish time of a job being executed exceeds a prescribed time which has been set in advance, suspends the job being executed and executes update processing of updating firmware.

### 2.1 Functional Configuration

Since functional configurations of a multifunction peripheral and a firmware providing apparatus according to the second embodiment can be made the same as those of the multifunction peripheral 10 and the firmware providing apparatus 30 according to the first embodiment, the functional configuration of the second embodiment will not be described here.

### 2.2 Flow of Processing

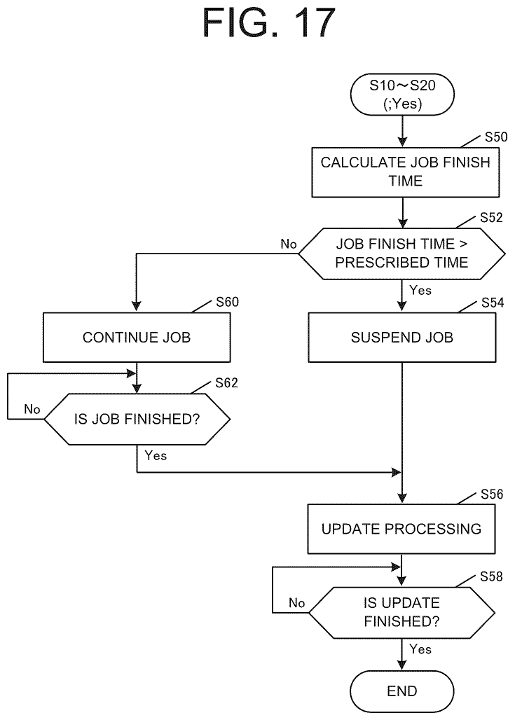

FIG. 17 is a flowchart illustrating a flow of processing according to the second embodiment. A flow of processing according to the second embodiment can be made in common with the processing from step S10 to step S20 (a flow with “Yes”) described with reference to FIG. 6 of the first embodiment. Therefore, a flow of processing subsequent to step S20 will be described.

In step S20 of FIG. 6, a controller 11 that has determined that a job is being executed calculates a finish time for the job to be finished (step S20; Yes→step S50). Next, the controller 11 determines whether the calculated job finish time exceeds a prescribed time which has been set in advance (step S50→step S52). Here, the prescribed time is not particularly limited. However, for example, in a case where it takes only several minutes to perform the update processing of updating the firmware, whereas it takes about several tens of minutes to finish the job being executed, prioritizing the firmware update processing over the job execution may be more preferable. In such a case, the prescribed time is set to, for example, five to ten minutes, and if a job which requires a processing time that exceeds the prescribed time is being executed, the job is suspended and the update processing of updating the firmware is processed as interrupt processing. By doing so, the update processing of updating the firmware can be completed without fail. Note that a threshold for shifting the processing to the update processing of updating the firmware may be, for example, a prescribed number of sheets to be printed which has been set in advance, other than the prescribed time mentioned above. If a job is a transmission job, a prescribed number of sheets to be transmitted may be applied as the threshold.

If it is determined that the job finish time exceeds the prescribed time, the controller 11 suspends the job (step S52; Yes→step S54). Then, the controller 11 executes processing of updating firmware, i.e., firmware update processing (step S56). The controller 11 determines whether the firmware update processing has been finished (step S58). If it is determined that the firmware update processing has been finished, the controller 11 ends the processing (step S58; Yes). Here, if it is determined that the firmware update processing has not been finished yet, the controller 11 continues the firmware update processing (step S58; No).

Incidentally, if it is determined in S52 that the job finish time does not exceed the prescribed time, the controller 11 continues the job (step S52; No→step S60). Then, the controller 11 determines whether the job has been finished (step S62). If it is determined that the job has been finished, the controller 11 executes the firmware update processing (step S62; Yes→step S56). Here, if it is determined that the job has not been finished yet, the controller 11 continues the job (step S62; No).

The controller 11 determines whether the firmware update processing started in step S56 has been finished (step S58). If it is determined that the firmware update processing has been finished, the controller 11 ends the processing (step S58; Yes). Here, if it is determined that the firmware update processing has not been finished yet, the controller 11 continues the firmware update processing (step S58; No).

### 2.3 Operation Examples

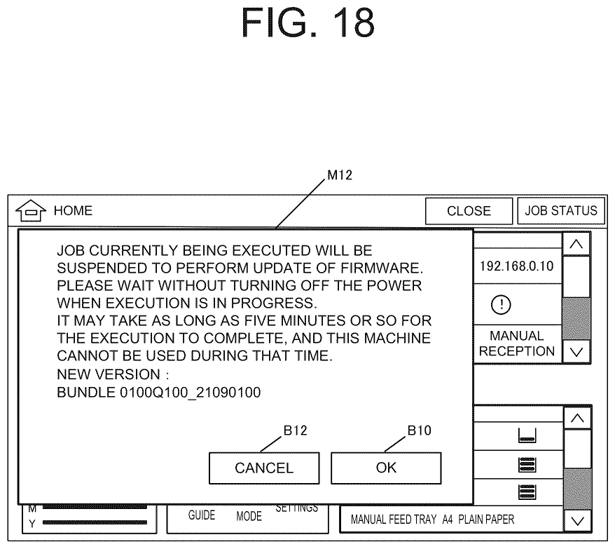

Next, operation examples according to the second embodiment will be described. FIG. 18 is a diagram illustrating a configuration example of a message screen M12 displayed by the controller 11 when a job being executed is suspended to execute firmware update processing.

FIG. 18 illustrates an example which displays, as a message screen M12, information indicating that a job currently being executed will be suspended and firmware update processing will be executed. An OK button B10 is a button which receives permission to update the firmware by the user of a multifunction peripheral 10. Further, a cancel button B12 is a button which receives rejection of the firmware update by the user of the multifunction peripheral 10. When the controller 11 of the multifunction peripheral 10 receives selection of the OK button B10 by the user, the controller 11 continuously executes the firmware update processing, and when the controller 11 receives selection of the cancel button B12, the controller 11 stops the firmware update processing and continues the job.

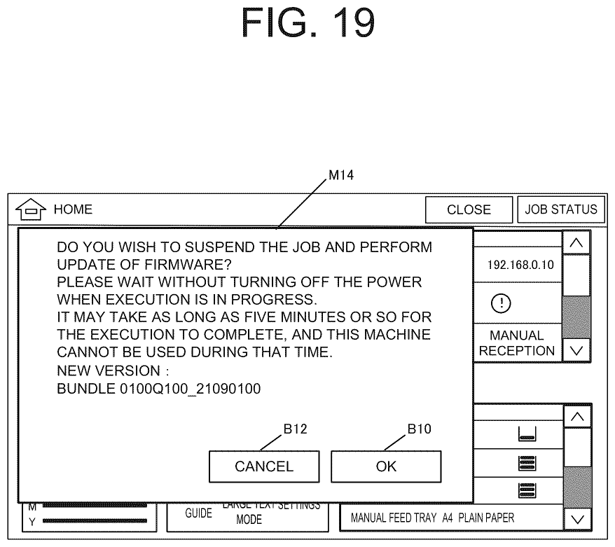

FIG. 19 is a diagram illustrating a configuration example of an inquiry screen M14 which makes an inquiry to the user whether the job is to be suspended to execute firmware update processing, in a case where it is determined in step S52 of FIG. 17 that the job finish time exceeds the prescribed time.

The controller 11 of the multifunction peripheral 10 displays the inquiry screen M14 exemplified in FIG. 19, and makes an inquiry to the user of the multifunction peripheral 10 in advance whether the job is to be suspended to execute the firmware update processing, whereby it is possible to prevent the firmware update processing from being executed against the user's intention.

As described above, according to the second embodiment, not only is it possible to obtain the advantages related to the first embodiment, but also, if the finish time of a job being executed exceeds a prescribed time which has been set in advance, it is possible to suspend the job being executed and execute the update processing of updating the firmware. Therefore, a more flexible operation can be carried out with respect to an update of the firmware.

### 3. Modification Example

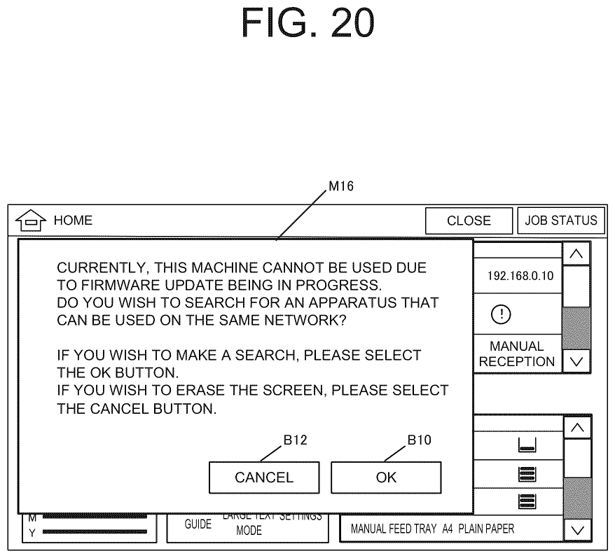

There may be a case where the multifunction peripheral 10 in the process of executing firmware update processing is unable to execute processing related to a job. In such a case, the controller 11 of the multifunction peripheral 10 may display, for example, a suggestion screen M16 suggesting other multifunction peripherals, which exist on the same network and have the processing ability capable of processing the job desired by the user, to the user. FIG. 20 is a diagram illustrating a configuration example of a suggestion screen M16 which suggests, during execution of the firmware update processing, other apparatuses that can be used to the user who wishes to execute the job. The suggestion screen M16 may display, for example, a message such as “Currently, this machine cannot be used due to firmware update being in progress. Do you wish to search for an apparatus that can be used on the same network? If you wish to make a search, please select the OK button. If you wish to erase the screen, please select the cancel button.”, as the display contents. By adopting such a configuration, even in a case where the multifunction peripheral 10 is unable to execute the processing related to the job due to the processing of updating the firmware, it is possible to prevent the productivity of the user from being decreased. The user can execute the desired job with no delay by using another apparatus suggested by the search on the network.

The present disclosure is not limited to the above-described embodiments, and various modifications can be made. That is, embodiments obtained by combining technical measures modified as appropriate within a range that does not depart from the gist of the present disclosure are also included in the technical scope of the present disclosure.

Further, although some parts of the above-described embodiments are described separately for convenience of explanation, it is needless to say that the embodiments may be combined and implemented within a technically possible range.

In addition, the program to be operated on each apparatus in the embodiments is a program that controls a CPU or the like (i.e., a program that causes a computer to function) so as to implement the functions of the above-described embodiments. The information handled by the apparatuses is temporarily accumulated in a temporary storage device (for example, a RAM) during processing of the information, and then, is stored in various storage devices such as a read-only memory (ROM) and an HDD, and is read, modified, and written by the CPU as necessary.

A recording medium used for storing the program may be any one of a semiconductor medium (for example, a ROM, a non-volatile memory card, or the like), an optical recording medium or a magneto-optical recording medium (for example, a digital versatile disc (DVD), a magneto-optical disc (MO), a mini disc (MD), a compact disc (CD), a Blu-ray® disc (BD), or the like), and a magnetic recording medium (for example, a magnetic tape, a flexible disk, or the like). Moreover, not only are the functions of the embodiments described above implemented by execution of a loaded program, but the functions of the present disclosure may also be implemented by processing performed in cooperation with an operating system or other application programs, etc., on the basis of an instruction of the program.

Furthermore, in the case of distributing the programs to the market, the programs may be stored in a portable recording medium for distribution or transferred to a server computer connected via a network such as the Internet. In this case, a storage device of the server computer is also included in the present disclosure as a matter of course.

In addition, functional blocks of the apparatus used in the above-described embodiments or various features thereof can be implemented or executed by means of electric circuitry, or more specifically, an integrated circuit or a plurality of integrated circuits, for example. The electric circuitry designed to realize the functions described in the present specification may include a general-purpose processor, a digital signal processor (DSP), an application-specific integrated circuit (ASIC), a field-programmable gate array (FPGA) or other programmable logic devices, a discrete gate or transistor logic, discrete hardware components, or a combination of the aforementioned elements. The general-purpose processor may either be a microprocessor or a conventional processor, a controller, a microcontroller, or a state machine. The electric circuitry described above may be constituted by a digital circuit or by an analog circuit. Moreover, if a technology for forming an integrated circuit that can be used as a substitute for the current integrated circuits is to emerge as a result of the progress of the semiconductor technology, one or more aspects of the present disclosure may use a new integrated circuit obtained by the emerging technology.

What is claimed is:

1. An image forming apparatus comprising:
a communication device which receives a remotely-given update instruction to update firmware;
a display device which displays an operation screen; and
a processor which controls processing related to an update of the firmware, wherein
the processor controls, based on the update instruction that has been received, display contents of the operation screen displayed by the display device or an update start timing of the firmware, according to an apparatus status at a time of the update.

2. The image forming apparatus according to claim 1, wherein the processor controls, based on the update instruction to update firmware that has been set in advance, the display contents of the operation screen displayed by the display device or the update start timing of the firmware, according to the apparatus status at the time of the update.

3. The image forming apparatus according to claim 1, wherein when the update instruction includes date and time specification which specifies an update date and time of the firmware, the processor displays, on the operation screen, a message which urges that the image forming apparatus should not be powered off on the update date and time.

4. The image forming apparatus according to claim 3, wherein the processor restricts a user's operation on the image forming apparatus at a time which is predetermined time before the update date and time.

5. The image forming apparatus according to claim 3, wherein when a job related to image formation is being executed at a time which is predetermined time before the update date and time, the processor waits for the job to be finished and then updates the firmware.

6. The image forming apparatus according to claim 5, wherein when a forced update setting to forcibly update the firmware is made, the processor suspends the job and updates the firmware.

7. The image forming apparatus according to claim 1, wherein in a case where the update of the firmware has been unable to be executed due to an apparatus malfunction at a time when the update start timing of the firmware arrived, the processor notifies a predetermined notification destination, and urges the update of the firmware.

8. The image forming apparatus according to claim 7, wherein the apparatus malfunction includes power-off, disconnection from a network line, an apparatus breakdown, or replacement of consumables of the image forming apparatus.

9. The image forming apparatus according to claim 7, wherein the processor starts the update of the firmware when the apparatus malfunction is resolved and the update instruction is received from an external terminal device.

10. A firmware update method comprising:
receiving a remotely-given update instruction to update firmware; and
controlling, based on the update instruction that has been received, display contents of an operation screen displayed by a display device or an update start timing of the firmware, according to an apparatus status at a time of the update.

11. A system comprising a processor and a memory in which commands are stored, the commands causing, when the commands are executed by the processor, the processor to perform:
outputting an update instruction to update firmware;
receiving the update instruction to update the firmware;
controlling, based on the update instruction that has been received, display contents of an operation screen to be displayed or an update timing of the firmware, according to an apparatus status at a time of an update; and
outputting the firmware when an update execution instruction for the firmware is received.
